(19) United States
(12) Patent Application Publication
(10) Pub. No.: US 2011/0296161 A1
(43) Pub. Date: Dec. 1, 2011

(54) COMPUTER SYSTEM

(75) Inventors: YUN-SHAN XIAO, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSSTY (ShenZhen) CO., LTD., Shenzhen City (CN)

(21) Appl. No.: 12/817,295

(22) Filed: Jun. 17, 2010

(30) Foreign Application Priority Data
May 31, 2010 (CN) 201010187411.8

(51) Int. Cl. G06F 9/00

(52) U.S. Cl. 713/100

(57) ABSTRACT

A computer system includes an enclosure and a motherboard. The enclosure includes two switches exposed through the enclosure. The motherboard is arranged in the enclosure and includes a reset pin to clear basic input output system (BIOS) settings of the motherboard. The reset pin is grounded by the two switches in series. The BIOS settings are cleared in response to the two switches being turned on.

### BACKGROUND

1. Technical Field

The present disclosure relates to a computer system.

2. Description of Related Art

In a computer system, part of basic input output system (BIOS) settings may be stored in a static random-access memory (SRAM) of an I/O controller hub (ICH) of the computer system. A dime size battery powers the SRAM of the ICH when the computer system is turned off, thus the SRAM of the ICH is not erased or deleted even when the computer system is turned off. To clear the SRAM of the ICH some computer systems offer jumper pins (reset pins), namely when the jumper pins are short circuited, a reset pin of the SRAM of the ICH of the computer system receives a low level voltage signal, and then the SRAM is cleared. However, to get to the reset jumper pins one must open an enclosure of the computer system, which is inconvenient. Therefore there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a circuit diagram of an embodiment of a computer system including an enclosure.

FIG. 2 is an isometric, schematic view of the enclosure of FIG. 1.

### DETAILED DESCRIPTION

The disclosure, including the accompanying drawing in which like references indicate similar elements, is illustrated by way of example and not by way of limitation. It should be noted that references to “an” or “one” embodiment in this disclosure are not necessarily to the same embodiment, and such references mean at least one.

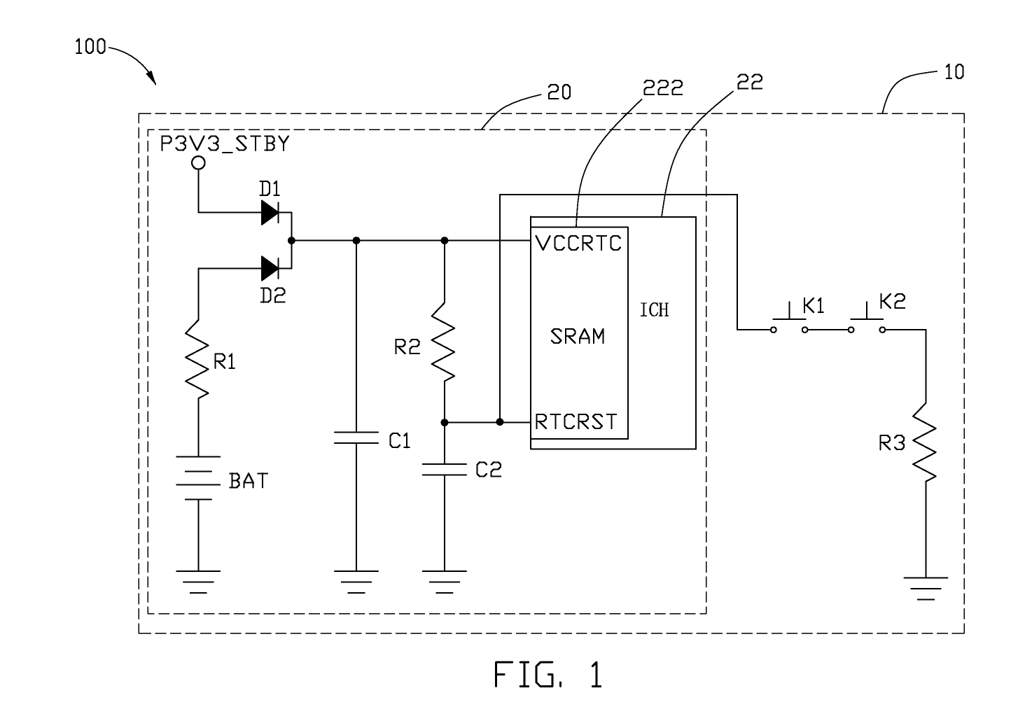

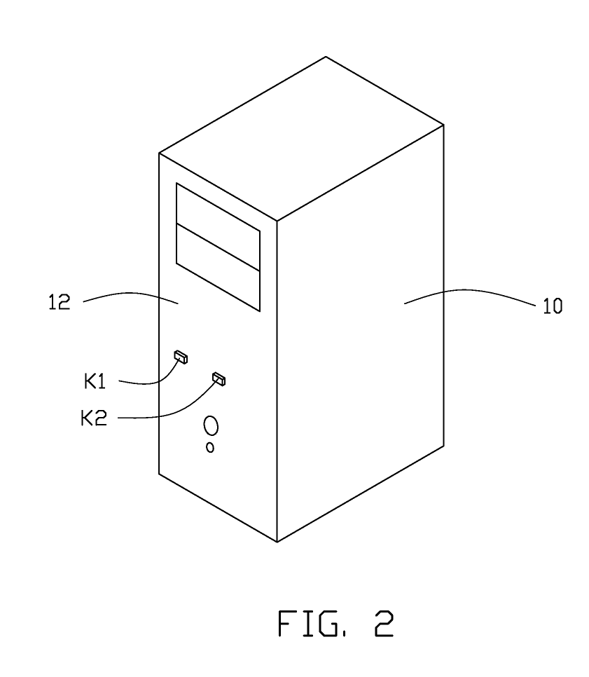

Referring to FIGS. 1 and 2, an embodiment of a computer system 100 includes an enclosure 10 and a motherboard 20 which is contained in the enclosure 10.

The enclosure 10 includes two switches K1 and K2 arranged on the front panel 12 of the enclosure 10. In other embodiments, the two switches K1 and K2 can be arranged in other locations on the surface of the enclosure 10.

The motherboard 20 includes a battery BAT, two diodes D1 and D2, an I/O controller hub (ICH) 22, two resistors R1 and R2, two capacitors C1 and C2, and a 3.3 volt (V) standby power input terminal P3V3_STBY.

The ICH 22 includes a static random-access memory (SRAM) 222 to store basic input output system (BIOS) settings. The SRAM 222 includes a voltage pin VCCRTC and a reset pin RTCRST. When the reset pin RTCRST of the SRAM 222 is set to a low voltage, such as 0V, all data stored in the SRAM 222 are cleared, therefore any BIOS settings of the computer system 100 stored in the SRAM 222 are deleted or lost.

The anode of the diode D1 is connected to the 3.3V standby power input terminal P3V3_STBY. The anode of the diode D2 is connected to the positive terminal of the battery BAT through the resistor R1. The negative terminal of the battery BAT is grounded.

The cathodes of the two diodes D1 and D2 are connected to the voltage pin VCCRTC of the SRAM 222 of the ICH 22, and also grounded through the capacitor C1. The voltage pin VCCRTC of the SRAM 222 of the ICH 22 is connected to the reset pin RTCRST of the SRAM 222 of the ICH 22 through the resistor R2. The reset pin RTCRST of the SRAM 222 of the ICH 22 is grounded through the capacitor C2. The reset pin RTCRST of the SRAM 222 of the ICH 22 is also grounded through the switch K1, the switch K2, and the resistor R3 in that order. In one embodiment, the two switches K1 and K2 are normal open switches.

When the motherboard 20 receives an external power, the 3.3V standby power input terminal P3V3_STBY supplies a 3.3V high voltage. When the motherboard 20 doesn't receive any external power, the battery BAT supplies a 3.3V high voltage. Therefore, the voltage pin VCCRTC and the reset pin RTCRST of the SRAM 222 of the ICH 22 are always at the 3.3V (the resistor R2 can be negligible). Namely, the voltage pin VCCRTC and the reset pin RTCRST of the SRAM 222 of the ICH 22 will always be at a high voltage of 3.3V, so that the BIOS settings stored in the SRAM 222 is not cleared even when the external power to the motherboard 20 is shutdown.

When users need to clear the BIOS settings stored in the SRAM 222, the two switches K1 and K2 are closed, therefore the reset pin RTCRST of the SRAM 222 of the ICH 22 receives a low voltage signal which clears the BIOS settings stored in the SRAM 222. Because the two switches K1 and K2 are arranged outside the enclosure 10, the enclosure does not need to removed and reinstalled, which is convenient. Furthermore, arranging two switches K1 and K2, rather than just one, prevents inadvertent clearing of the CMOS because both switches K1 and K2 must be closed simultaneously.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A computer system comprising:
an enclosure comprising two switches exposed through the enclosure; and
a motherboard arranged in the enclosure and comprising a reset pin to clear basic input output system (BIOS) settings of the motherboard;
wherein the reset pin is grounded through the two switches in series, the BIOS settings are cleared in response to the two switches being closed simultaneously.

2. The computer system of claim 1, further comprising a resistor connected between the two switches and ground.

3. The computer system of claim 1, wherein the two switches are normal open switches.

4. The computer system of claim 1, wherein the motherboard comprises an I/O controller hub (ICH) comprising a static random-access memory (SRAM), the reset pin is a reset pin of the SRAM.

5. The computer system of claim 4, wherein the motherboard further comprises a battery, first and second diodes, first and second resistors, first and second capacitors, and a standby power input terminal, the anode of the first diode is connected to the standby power input terminal, the anode of the second diode is connected to the positive terminal of the battery through the first resistor, the negative terminal of the battery is grounded, the cathodes of the first and second diodes are connected to a voltage pin of the SRAM of the ICH and also grounded through the first capacitor, the voltage pin of the SRAM of the ICH is connected to the reset pin of the SRAM of the ICH through the second resistor, the reset pin of the SRAM of the ICH is also grounded through the second capacitor.
